(19) United States
(12) Patent Application Publication
(10) Pub. No.: US 2026/0077802 A1
(43) Pub. Date: Mar. 19, 2026

(54) MULTI-TURN STEERING FEEDBACK ACTUATOR

(71) Applicant: Tesla, Inc., Austin, TX (US)

(72) Inventors: Stephen Alexander Harasym, San Francisco, CA (US); Joel Timothy Van Rooyen, Alameda, CA (US)

(21) Appl. No.: 18/888,687

(22) Filed: Sep. 18, 2024

(51) Int. Cl. B62D 5/00; B62D 1/16

(52) U.S. Cl. CPC B62D 5/006; B62D 1/16

(57) ABSTRACT

A steering column assembly of a multi-turn steering feedback actuator system includes a shaft rotatable about an axis of rotation. A shaft stop extends radially outward from the axis of rotation. A housing includes a housing stop. A rotating member is rotatable about the axis of rotation and includes a first stop that prevents rotation of the shaft relative to the rotating member in a first direction when engaging the shaft stop, and prevents rotation of the shaft relative to the rotating member in a second direction opposite the first direction when engaging the shaft stop. The rotating member also has a second stop that prevents rotation of the rotating member relative to the housing in the first direction when engaging the housing stop, and that prevents rotation of the rotating member relative to the housing in the second direction when engaging the housing stop.

### TECHNICAL FIELD

The present disclosure generally relates to vehicle steering systems and more particularly to multi-turn steering wheel feedback actuators.

### BACKGROUND

Steer-by-wire (SbW) systems in modern vehicles utilize steering feedback actuators to provide resistive force feedback to the driver, emulating the sensation of traditional mechanical steering systems. These actuators typically incorporate travel limiters or stops to prevent excessive steering wheel rotation and protect other steering components. Conventional SbW actuators often employ mechanical pins or stoppers within the housing to limit the steering wheel's range of motion. These mechanisms are designed to provide a rigid end stop at predetermined angles, commonly around ±170 degrees from the center position (180 degrees, typically reduced by about 10 degrees or more by the width of the components coming into contact with each other). The travel limiters not only prevent continuous rotation of the steering wheel but also serve to protect other components in the steering system that may have limited allowable ranges of motion.

### BRIEF SUMMARY

Examples described herein provide a multi-turn steering feedback actuator system for steer-by-wire systems that allows for extended steering wheel rotation range while still incorporating a robust end stop mechanism. Some examples of a multi-turn steering feedback actuator system include a steering column assembly having a relatively simple mechanical structure. The steering column assembly has an input shaft with a pin, a housing, and a stop ring with two stops: a first stop for engaging the housing, and a second stop for engaging the pin of the input shaft. This configuration can enable steering ranges of up to around ±340 degrees, which is significantly more than conventional systems, while maintaining a compact and efficient package. In some examples, the steering column assembly can be coupled to a steering feedback actuator to provide feedback to the driver.

In some examples, the steering column assembly of the multi-turn steering feedback actuator system is adjustable, allowing the range of motion to be tuned by a designer to any value between around ±170 and around ±340 degrees by modifying the configuration of the stop ring's two stops. In some examples, the steering column assembly incorporates damping elements, such as O-rings positioned to protrude from contact surfaces, to provide a softer, more premium feel when reaching the end stops. Improved haptic feedback can enhance the overall steering experience for the driver.

Some example steering column assemblies described herein can be integrated with existing feedback systems by utilizing a gear or pulley on the input shaft to connect to a belt drive system and motor. This integration may allow for variable feedback torque generation, with the ability to produce variable amounts of feedback at the hand wheel in some cases. In addition, some examples can provide a relatively simple design, using minimal parts, thereby potentially improving reliability and/or reducing costs while still providing robust performance capable of withstanding high input torques.

### BRIEF DESCRIPTION OF THE DRAWINGS

Throughout the drawings, reference numbers may be re-used to indicate correspondence between referenced elements. The drawings are provided to illustrate examples of the subject matter described herein and not to limit the scope thereof.

FIG. 1 is a system diagram illustrating an architecture of an electric vehicle (EV), according to some examples.

FIG. 2 shows an isometric exploded view of a steering column assembly of a multi-turn steering feedback actuator system, illustrating internal components and their arrangement within a housing, according to some examples.

FIG. 3 illustrates a front view of the multi-turn steering feedback actuator system of FIG. 2, according to some examples.

FIG. 4 illustrates a left side view of the multi-turn steering feedback actuator system of FIG. 2, according to some examples.

FIG. 5 illustrates a detailed cross-sectional view of the steering column assembly of FIG. 2 through line 4-4 of FIG. 3, according to some examples.

FIG. 6 illustrates a detailed cross-sectional view of the steering column assembly of FIG. 2 through line 5-5 of FIG. 4, according to some examples.

FIG. 7A illustrates a simplified cross-sectional front view of the rotating member and shaft of FIG. 2 through line A-A of FIG. 6, according to some examples.

FIG. 7B illustrates a simplified cross-sectional front view of the rotating member and a portion of the housing of FIG. 2 through line B-B of FIG. 6, according to some examples.

FIG. 8A illustrates the simplified cross-sectional front view of FIG. 7A, showing the shaft rotating through a third arc starting from a first end position, according to some examples.

FIG. 8B illustrates the simplified cross-sectional front view of FIG. 7B, showing the rotating member rotating through a fourth arc ending at a second end position, according to some examples.

FIG. 9 is a flow diagram showing operations of a method for rotating a steering column across a range of motion of more than ±180 degrees, according to some examples.

FIG. 10 illustrates an isometric upper-front partial view of selected components of the steering column assembly of FIG. 2 within the housing, according to some examples.

FIG. 11 illustrates the isometric upper-front partial view of FIG. 10 omitting the shaft for greater visibility, according to some examples.

FIG. 12 illustrates an isometric front-left side partial view of selected components of the steering column assembly of FIG. 2 within the housing, according to some examples.

### DETAILED DESCRIPTION

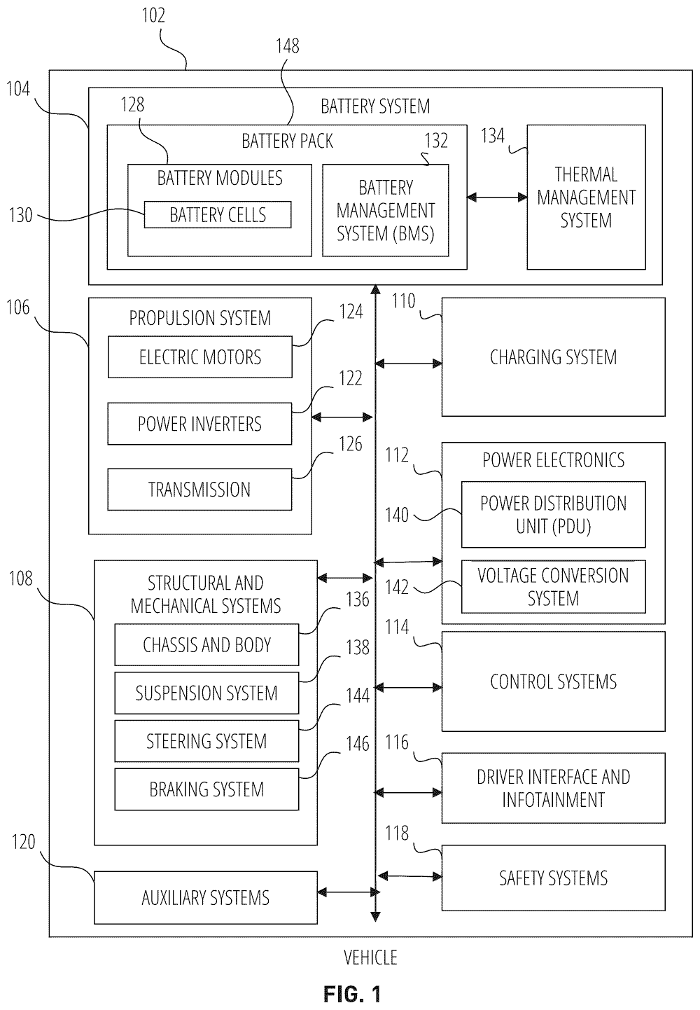

FIG. 1 is a system diagram illustrating an architecture of an electric vehicle (EV) 102, according to some examples. This diagram shows systems and sub-systems that collectively enable the functionality and operational efficiency of the electric vehicle 10.

The vehicle 102 includes a number of higher-level systems which are interconnected, including a battery system 104, a propulsion system 106, structural and mechanical systems 108, a charging system 110, power electronics 112, control systems 114, driver interface and infotainment 116, safety systems 118, and auxiliary systems 120.

The propulsion system 106 includes one or more electric motors 124, which may include traction motors for propulsion and motors for regenerative braking systems, convert electrical energy into mechanical energy. Power inverters 122, facilitate the conversion of DC power from the battery to AC power required by the electric motors 124. The propulsion system also includes a transmission 126, which may consist of a single-speed transmission or gearbox, channeling mechanical power to the vehicle's wheels.

The battery system 104 includes a battery pack 148 containing several battery modules 128, each housing multiple battery cells 130. These battery cells 130 may be based on various chemistries, including lithium-ion, lithium-polymer, or solid-state materials, each offering distinct advantages in terms of energy density, recharge cycles, and safety profiles. The battery pack 148 includes a battery enclosure that surrounds and encloses the components of the battery pack 148.

A battery management system (BMS 132) continuously monitors various parameters, such as voltage, current, and temperature of each of the battery cells 130 and battery modules 128, to prevent conditions that could lead to overcharging, deep discharging, or thermal runaway. The BMS 132 also manages the state of charge (SoC) and state of health (SoH) of the battery, ensuring that the energy is distributed during discharge and that the charging process is optimized for longevity and safety. Each BMS 132 employs algorithms to balance the charge across the cells and modules, correcting imbalances that can reduce the battery's overall capacity and lifespan.

Integrated with the battery system 104 is a thermal management system 134, which operatively maintains the battery cells 130 within specified temperature ranges. The thermal management system 134 employs temperature sensors to monitor the heat generated by the battery cells 130 during operation. Based on the data collected, it activates cooling and heating mechanisms to regulate the battery's temperature. Cooling methods can include air cooling, where ambient air is circulated around the battery modules, or liquid cooling, where a coolant is circulated through channels in or around the battery modules to absorb and dissipate heat. In colder environments, the thermal management system 134 may employ heating elements or use waste heat from the vehicle's systems to warm the battery cells, ensuring they operate efficiently even in low temperatures.

The charging system 110 operatively replenishes the stored energy within the battery system 104 of the electric vehicle 102. It supports various charging methodologies to ensure flexibility and convenience in energy restoration. The charging system 110 may encompass systems for both standard (Level 1 and Level 2) and fast charging (DC fast charging), facilitating a range of charging speeds to suit different user needs and infrastructure capabilities.

For standard charging, the charging system 110 includes an onboard charger for AC/DC conversion. This onboard charger converts the alternating current (AC) from the electrical grid or home outlets into direct current (DC) that can be stored in the vehicle's battery system 104. The onboard charger may, for example support Level 1 and Level 2 charging, with Level 1 charging using standard household outlets (108-120V) and Level 2 charging requiring a higher voltage source (208-240V), such as those found in dedicated charging stations or installed in residential garages.

For fast charging, the charging system 110 may incorporate a DC fast charging system, designed for rapid energy transfer directly to the vehicle's battery system 104, bypassing the onboard charger. DC fast charging stations supply high-voltage (e.g., 400V to 800V) direct current directly to the battery system 104.

Additionally, the electric vehicle 102 may be equipped with an auxiliary battery, such as a 12V lead-acid or lithium-ion battery may be tasked with powering the vehicle's low-voltage systems, including lighting, infotainment, electronic control units, and other ancillary components, ensuring their operation even when the main battery system is off or during the initial stages of charging when the main system's voltage might be too low for these tasks. This separation of power sources enhances the vehicle's electrical system reliability and ensures the availability of essential functions.

Structural and mechanical systems 108, including a chassis and body 136 and suspension system 138, provide the physical framework and support for the vehicle 102. The chassis and body 136 constitute the vehicle's primary structure, while the suspension system 138, which may include springs, shock absorbers (or dampers), and control arms, to provide a smooth and stable ride by mitigating road shocks and vibrations.

Power electronics 112, including a power distribution unit (PDU) 140 and a voltage conversion system 142, are responsible for the management and conversion of electrical power within the vehicle. The power distribution unit (PDU) 140, equipped with fuses and relays, distributes power to various vehicle systems, while voltage conversion devices of the voltage conversion system 142, such as DC/DC and AC/DC converters, adjust the voltage levels to meet the specific requirements of different components.

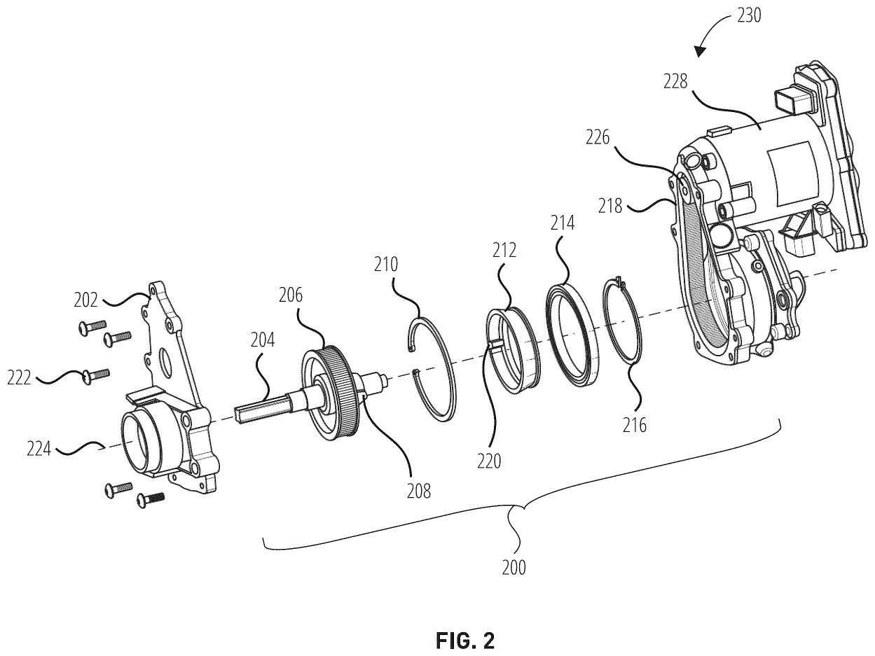

Control systems 114 facilitate the driver's command over the vehicle, with a steering system 144 and a braking system 146 as examples. The steering system 144, including a power steering motor, allows for precise directional control, whereas the braking system 146, which may feature disc brakes and an anti-lock braking system (ABS), enables deceleration and stopping. In some examples, the steering system 144 includes a Steer by Wire (SbW) system having a multi-turn steering feedback actuator system as described below in reference to FIG. 2 through FIG. 12. The multi-turn steering feedback actuator system can incorporate a steering column assembly that enables a range of motion of greater than ±180 degrees from a neutral position while providing a travel stop to rotation of the steering wheel and providing haptic feedback to a driver.

The driver interface and infotainment 116 supports the driving experience by providing vehicle information and entertainment options through digital displays and multimedia systems. Connectivity features, such as Bluetooth and USB, further augment functionality.

Safety systems 118, designed to protect the vehicle's occupants, may include airbag systems and advanced driver-assistance systems (ADAS), for example. ADAS may use an array of sensors, cameras, radar, LiDAR, and/or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver performs all driving tasks, to Level 5, which represents full automation with no human intervention required under any circumstances. Levels 1 and 2focus on driver assistance and partial automation, respectively, where systems such as adaptive cruise control, lane-keeping assistance, and automatic emergency braking support the driver but do not replace them. Level 3, conditional automation, allows the vehicle to handle all aspects of driving in certain conditions, but requires the driver to be ready to take control when needed. Level 4, high automation, enables the vehicle to operate independently in most scenarios, though human override is still possible.

Examples of ADAS that contribute to these levels of automation include, but are not limited to, adaptive cruise control, which adjusts the vehicle's speed to maintain a safe distance from vehicles ahead; lane departure warning systems, which alert the driver when the vehicle begins to drift out of its lane; and automatic parking systems, which assist or take over control of the vehicle during parking maneuvers. More advanced systems, contributing to higher levels of automation, involve complex algorithms and machine learning capabilities to interpret sensor data, predict actions of other road users, and make real-time driving decisions.

Auxiliary systems 120 support the vehicle's functions and occupant comfort, with climate control and lighting systems as examples. The auxiliary systems 120 may also include windshield wipers etc.

As noted above, the systems of the vehicle 102 are communicatively connected. Communications between the interconnected systems within vehicle 102 are facilitated through a vehicle network architecture, employing both hardware and software components to ensure seamless data exchange and coordination. This network architecture may include one or more vehicle communication buses, such as for example Controller Area Network (CAN), Local Interconnect Network (LIN), FlexRay®, and Ethernet, which serve as the backbone for intra-vehicle communications.

The Controller Area Network (CAN) bus is a vehicle bus standard designed to allow microcontrollers and devices to communicate with each other within the vehicle 102 without a host computer. Such a network may support control communications between systems such as the battery system 104, propulsion system 106, and control systems 114, due to its high reliability and resistance to interference. A CAN bus may support messages that ensure real-time control and monitoring of these systems.

For other communications, such as those involving the driver interface and infotainment 116 or auxiliary systems 120, a Local Interconnect Network (LIN) bus may be employed. LIN may provide a cost-effective, low-speed serial communication system for connecting intelligent sensors and actuaries. It may serve as a sub-network to the CAN bus, handling signals such as switch inputs and actuator outputs.

FlexRay® technology offers a higher data rate compared to CAN and LIN, providing the necessary bandwidth for advanced control systems, including those required for autonomous driving functionalities within safety systems 118. Its deterministic nature and fault tolerance make it suitable for applications that require precise timing and synchronization, such as coordinating the actions of multiple control units in real-time.

Ethernet, with its high data transfer rate, may for example be adopted for diagnostics and infotainment applications within the vehicle 102. It supports the rapid transfer of large volumes of data, making it well suited for advanced driver assistance systems (ADAS), software updates, and multimedia streaming in the driver interface and infotainment 116 system.

Software protocols and application programming interfaces (APIs) built on top of these physical layers enable high-level communication and data exchange between systems. These protocols may define the rules for data format, timing, and error handling, ensuring that messages are correctly interpreted and acted upon by the receiving systems.

FIG. 2 shows an isometric exploded view of a steering column assembly 200 of a multi-turn steering feedback actuator system 230, illustrating internal components and their arrangement within a housing 218, according to some examples. Whereas the multi-turn steering feedback actuator system 230 may be described in the context of electric vehicle 10, it will be appreciated that the multi-turn steering feedback actuator system 230 can be used with any mode of powertrain, or with any propulsion or electrical system.

The steering column assembly 200 comprises several components arranged along an axis of rotation 224. These components are arranged within a housing 218, closed with a housing cover 202. The steering column assembly 200 within the housing 218 communicates with an actuator 226 housed within an actuator housing 228 via a cavity, passage, or aperture within the housing 218.

The housing 218 (as well as the housing cover 202 and actuator housing 228) is fixedly attached to the vehicle (e.g., vehicle 102 of FIG. 1).

The housing cover 202 forms the outer enclosure of the assembly, providing protection and support for the internal components. It is designed to integrate with the housing 218, which serves as the main structural element of the steering column assembly 200.

The shaft 204 is a central component of the steering column assembly 200 that rotates about the axis of rotation 224. The shaft 204 is connected to a steering wheel (not shown) or other steering handle and transmits the driver's input to the steering system 144 (described above in reference to FIG. 1).

A gear 206 is mounted on, or extends radially outward from, the shaft 204. The gear 206 may be part of a belt drive system or other type of drive mechanism (e.g., a gear train) that mechanically couples the shaft 204 to the actuator 226, allowing for the transmission of feedback forces to the steering wheel. The actuator 226 can thereby provide force feedback to the steering system 144, simulating road feel and resistance in the steer-by-wire system.

The shaft stop 208 is a component that extends radially outward from the shaft 204. It serves as a mechanical limit for the rotation of the shaft 204, interacting with other components to restrict the angular range of motion of the shaft 204.

A first circlip 210 is visible in the steering column assembly 200. Circlips are retaining rings used to secure components in their proper positions within the assembly.

The rotating member 212 is a component of the steering column assembly described in greater detail below. The rotating member 212 may be referred to herein as a stop ring, and the two terms may be used interchangeably. The rotating member 212 rotates about the axis of rotation 224 and includes stops that interact with both the shaft stop 208 and the housing 218 to control the range of motion of the steering system, and in particular the range of motion of the shaft 204.

A bearing 214 is incorporated into the steering column assembly 200 to facilitate smooth rotation of the moving components while maintaining proper alignment. In some examples, the bearing 214 includes to annular portions arranged concentrically with an array of ball bearings between them, facilitating smooth rotation of the two annular portions relative to each other. In operation, the rotating member 212 can be fitted within the inner annular portion of the bearing 214 while the outer annular portion of the bearing 214 is fitted to a portion of the housing 218, thereby enabling smooth rotation of the rotating member 212 relative to the housing 218.

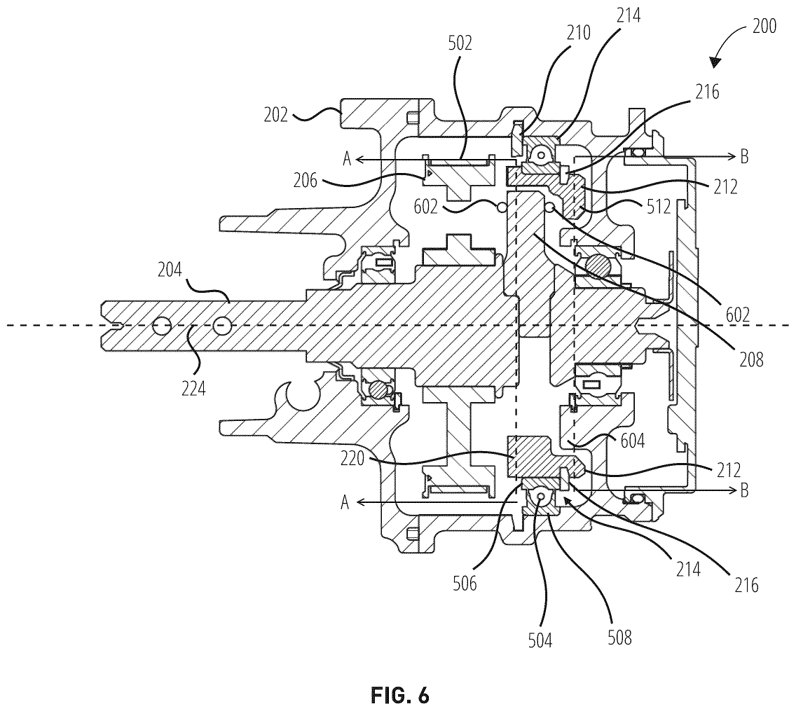

A second circlip 216 is also present in the steering column assembly 200, serving to secure the bearing 214 to the rotating member 212. In some examples, the first circlip 210 serves to secure the bearing 214 to the housing 218. Further details of an example relationship among the first circlip 210, rotating member 212, bearing 214, and second circlip 216 are illustrated in the cross-sectional view of FIG. 6, described below.

The housing 218 forms the main body of the steering column assembly. It provides mounting points for other components and may include features that interact with the rotating member to limit its motion. As noted above, the housing 218 defines a cavity, passage, or aperture to allow mechanical coupling of the actuator 226 to the gear 206 via a drive belt (not shown) or other drive mechanism.

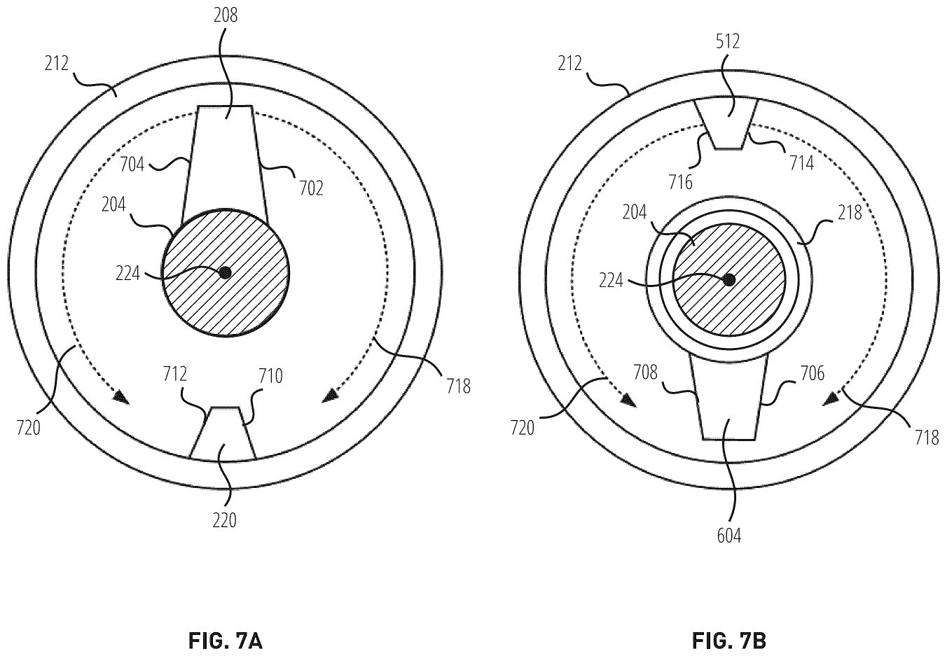

A first stop 220 of the rotating member 212 is visible in FIG. 1. The first stop 220 engages the shaft stop 208 to define the limits of rotation for the steering system. The rotating member 212 also includes a second stop, not visible in FIG. 1, that also operates to define the limits of rotation for the steering system by engaging a housing stop (also not visible) extending from the interior of the housing 218. Examples of a relationship among the shaft stop 208, first stop 220, second stop, and housing stop are illustrated in FIG. 7A through FIG. 12, described below.

In some examples, the housing cover 202 can be secured to the housing 218 by one or more screws 222 or other fasteners.

The axis of rotation 224 is the central line about which the shaft 204, rotating member 212, and other rotational components rotate.

Thus, in some examples, the multi-turn steering feedback actuator system 230 has a steering column assembly 200 that includes a shaft 204, a housing 218, a rotating member 212, and an actuator 226 coupled to the shaft 204 by a drive mechanism, the actuator 226 providing force feedback to the shaft 204 via the drive mechanism.

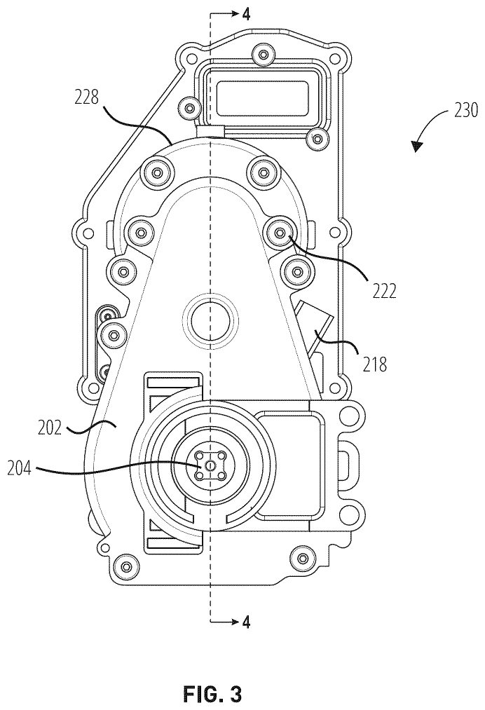

FIG. 3 illustrates a front view of the multi-turn steering feedback actuator system 230 of FIG. 2. The housing cover 202 is visible in this view, forming the outer protective enclosure for the steering column assembly 200. The housing cover 202 is designed to integrate with the housing 218, secured in this example by screws 222, to provide a complete and secure housing for the internal mechanisms. In this front view, it can be seen how the housing 218 provides structural support and mounting points for other components within the assembly.

The shaft 204 is shown in the center of the assembly, extending out of the plane of the drawing.

The actuator housing 228 is shown in this front view, enclosing and supporting the actuator (not visible in this view), which is responsible for providing force feedback to the steering system.

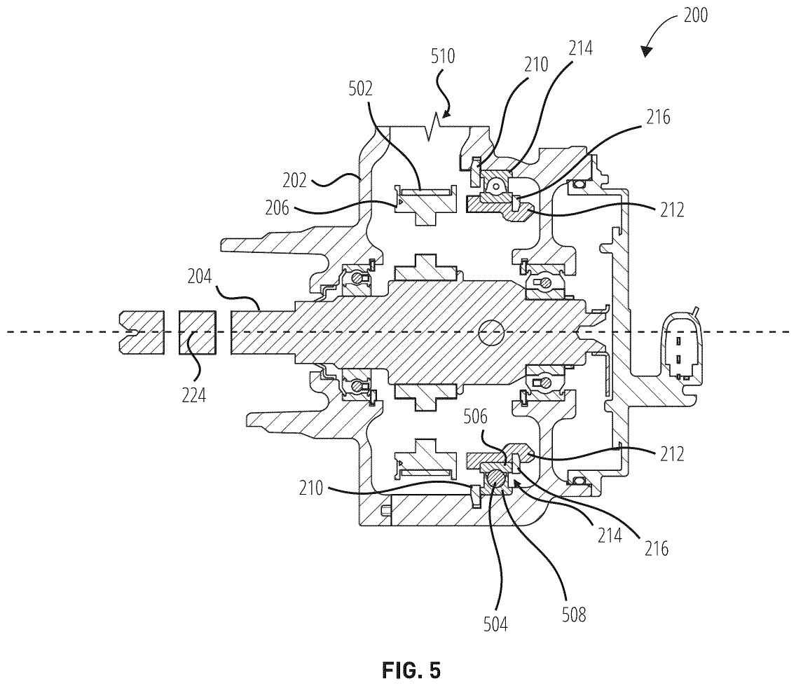

Line 4-4 defines a cross-section shown in the cross-sectional view of FIG. 5, described below. It will be appreciated that line 4-4 passes through the axis of rotation 224, such that the planar cross-section is coplanar with the axis of rotation 224.

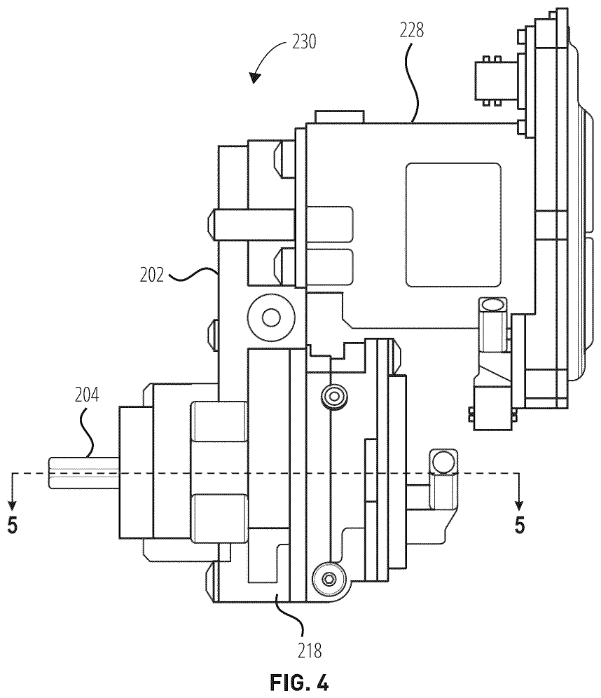

FIG. 4 illustrates a left side view of the multi-turn steering feedback actuator system 230 of FIG. 2.

FIG. 4 provides more detail of the relationship of the housing 218, housing cover 202, actuator housing 228, and shaft 204 to each other.

Line 5-5 defines a cross-section shown in the cross-sectional view of FIG. 6, described below. It will be appreciated that line 5-5 passes through the axis of rotation 224, such that the planar cross-section is coplanar with the axis of rotation 224.

FIG. 5 illustrates a detailed cross-sectional view of the steering column assembly of FIG. 2 through line 4-4 of FIG. 3. This view provides a comprehensive look at the internal components and their arrangement within the assembly.

The housing cover 202 is shown enclosing the front portion of the assembly, providing protection and support for the internal components. It will be appreciated that the front portions of the housing cover 202 and shaft 204 may change or omit some details in this view, without altering the principles by which the steering column assembly 200 and multi-turn steering feedback actuator system 230 operate as described herein.

The shaft 204 is visible as the central component, extending through the steering column assembly 200. The shaft 204 rotates about the axis of rotation 224 and is responsible for transmitting the driver's steering inputs to the steering system 144 (FIG. 1). In some examples, the shaft 204 is coupled to one or more sensors to implement steer-by-wire input for the steering system 144, such that rotation of the shaft 204 about the axis of rotation 224 generates steer-by-wire input data for the steering system 144.

The gear 206 is shown mounted on or extending outward from (in this view, above and below) the shaft 204. The gear 206 is fixedly (e.g., non-rotationally) coupled to the shaft 204. The gear 206 couples to a belt drive or other drive system that mechanically couples the shaft 204 to the actuator (not shown) for providing feedback forces to the steering wheel. The gear 206 has a gear surface 502, such as a toothed surface or high-friction surface, for engaging a belt drive, gear train, or other drive mechanism and thereby transmitting rotational motion from the actuator to the shaft 204. The drive mechanism extends between the steering column assembly 200 and the actuator via a passage 510 joining the cavity defined with in the housing 218 to a cavity within the actuator housing (not shown) where the actuator resides, as shown in FIG. 2. Thus, in some examples, the shaft 204 comprises an outer radial surface (e.g., the gear surface 502) for engaging the drive mechanism.

The first circlip 210 is shown securing the outer annular portion 508 of the bearing 214 to the housing 218. The second circlip 216 is shown securing the outer annular portion 508 of the second circlip 216 to the rotating member 212. Ball bearings 504 are shown between the outer annular portion 508 and the inner annular portion 506. The inner annular portion 506 and outer annular portion 508 provide races for the ball bearings 504 and facilitate smooth rotation of the bearing 214, and thereby the rotating member 212, relative to the housing 218.

FIG. 6 illustrates a detailed cross-sectional view of the steering column assembly of FIG. 2 through line 5-5 of FIG. 4. Many of the same components visible in FIG. 5 are also visible in FIG. 6.

The shaft stop 208 is visible in this view, extending radially outward from the shaft 204. The shaft stop 208 rotates with the shaft 204, as described in greater detail below with reference to FIG. 7A through FIG. 12.

Also in this view, a first stop 220 is visible on the rotating member 212. The first stop 220 engages the shaft stop 208 to limit rotation of the shaft 204 relative to the rotating member 212.

A second stop 512 is also visible on the rotating member 212. The second stop 512 interacts with a housing stop 604 shown extending from the housing 218 to limit rotation of the rotating member 212 relative to the housing 218.

An O-ring 602 is shown encircling the shaft stop 208 in this view. The O-ring 602 serves as a resilient, compressible damping element to provide a softer feel when the stops engage. In some examples, O-rings or other resilient, compressible components or coatings can be used on one or more of the stops to improve noise, feel, and impact forces when the stops engage each other. Thus, in some examples, the first and second surfaces of the stops described herein may be abutments such as O-rings presenting a relatively small engagement surface, but which may expand upon impact, providing resistance against further rotation and eventually preventing such rotation as the expansive force of the O-ring or other abutment overcomes the torque applied to the shaft 204. The term “surface” as used herein includes such abutments providing only a small surface or a single point of contact for engaging another surface or abutment.

FIG. 6 shows two further cross-sectional lines, line A-A and line B-B, defining the simplified cross-sectional views of FIG. 7A and FIG. 7B, respectively. It will be appreciated that the components seen in the A-A plane of FIG. 7A are therefore displaced along the axis of rotation 224 from the components seen in the B-B plane of FIG. 7B.

FIG. 7A is a simplified cross-sectional front view of the rotating member 212 (including the first stop 220) and shaft 204 (including the shaft stop 208) of the steering column assembly 200, taken through line A-A of FIG. 6.

The shaft 204 is shown rotating about the axis of rotation 224, which extends out of the plane of the drawing. The shaft stop 208 is depicted as a pin extending radially outward from the shaft 204, and may be referred to herein as a pin or a shaft pin. The shaft stop 208 serves as a mechanical limit for the rotation of the shaft 204, interacting with other components to restrict the range of angular motion of the shaft 204.

The rotating member 212 is shown surrounding the shaft 204. The rotating member 212 includes a first stop 220 extending radially inward toward the shaft 204.

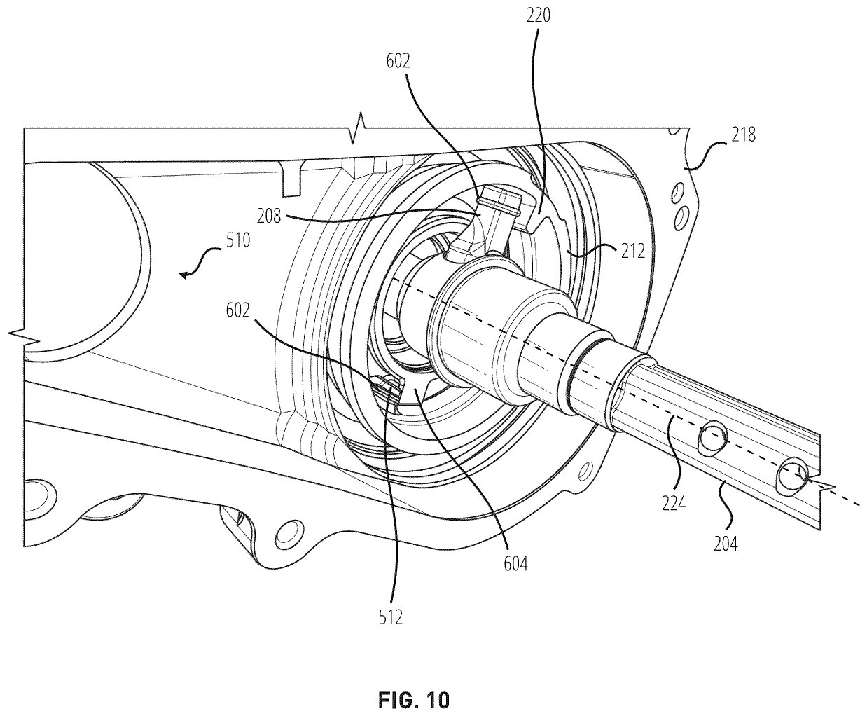

The shaft stop 208 and first stop 220 are shown in this illustration having simple geometric shapes; more detailed examples of shapes for these stops and the other stops described herein are shown in FIG. 10 through FIG. 12. In some examples, the shaft stop 208 and/or the first stop 220 can be formed as a flange or other protrusion extending around a significant angular portion of the shaft 204 or the rotating member 212, respectively. Whereas the shaft stop 208 and the first stop 220 are each shown as a single protrusion or bump in the illustration of FIG. 7A, in some examples the shaft stop 208 and/or the first stop 220 can be formed as two or more separate protrusions or bumps at different angular positions.

The shaft stop 208, first stop 220, and/or other components intended to perform a travel stop function for the steering column assembly 200 (such as the shaft 204 and/or the rotating member 212) can be formed from a suitable material capable of absorbing impact forces from the steering wheel reaching the end of its range of motion without deforming, such as steel or aluminum.

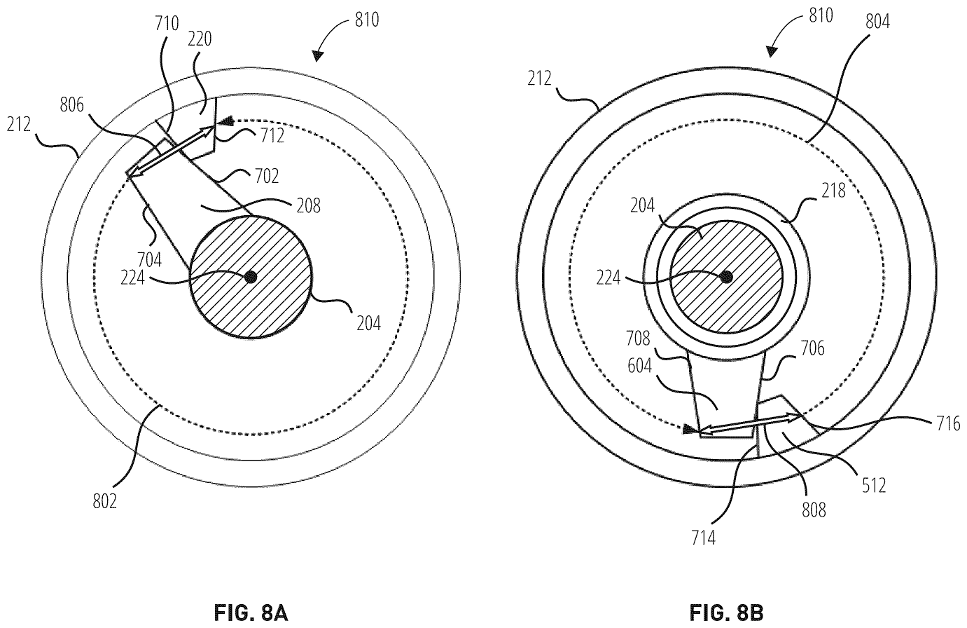

The shaft stop 208 and first stop 220 interact to limit the range of rotational movement of the shaft 204 relative to the rotating member 212. From the example neutral position of the shaft 204 shown in FIG. 7A, the shaft 204 can rotate in a first direction 718 (clockwise, in this example) over a first arc before a first surface 702 of the shaft stop 208 engages a first surface 710 of the first stop 220, or the shaft 204 can rotate in a second direction 720 (counterclockwise, in this example) over a second arc before a second surface 704 of the shaft stop 208 engages a second surface 712 of the first stop 220. The relative angular distance covered by the first arc and second arc depend on the initial position of the rotating member 212, as well as the widths of the shaft stop 208 and first stop 220, as described in greater detail below with reference to FIG. 8A.

As noted above, the engagement surfaces of one or both of the shaft stop 208 or first stop 220 can include resilient and/or compressible material, such as a natural or synthetic polymer forming a contact member (e.g., an O-ring) or a surface coating.

After the shaft stop 208 engages the first stop 220 while rotating in the first direction 718, any further rotation of the shaft 204 in the first direction 718 causes the rotating member 212 to rotate with the shaft 204 in the first direction 718. Similarly, after the shaft stop 208 engages the first stop 220 while rotating in the second direction 720, any further rotation of the shaft 204 in the second direction 720 causes the rotating member 212 to rotate with the shaft 204 in the second direction 720. The rotation of the rotating member 212 in either direction is arrested only by a further stop mechanism, an example of which is illustrated in FIG. 7B.

FIG. 7B shows a simplified cross-sectional front view of the rotating member 212 and a portion of the housing 218 through line B-B of FIG. 6.

The rotating member 212 is shown having a second stop 512. In this example, the second stop 512 protrudes or extends from the rotating member 212 radially inward, like the first stop 220. The second stop 512 travels with the rotation of the rotating member 212 in the first direction 718 and the second direction 720. The rotation of the rotating member 212 is arrested when the second stop 512 comes into contact with the housing stop 604, shown as a member extending radially outward away from the axis of rotation 224 and toward the rotating member 212. The housing stop 604 is affixed to or formed integrally with a portion of the housing 218: the cross-sectional view of FIG. 6 provides an example of how the second stop 512 extends from a surface of an otherwise obstruction-free annular cavity defined by the housing 218.

The rotating member 212 can rotate in the first direction 718 until the first surface 714 of the second stop 512 engages the first surface 706 of the housing stop 604, at which point the rotation of the rotating member 212 is arrested by the fixed location of the housing stop 604, which does not rotate. Similarly, the rotating member 212 can rotate in the second direction 720 until the second surface 716 of the second stop 512 engages the second surface 708 of the housing stop 604, at which point the rotation of the rotating member 212 is arrested by the fixed location of the housing stop 604.

The geometry, materials, and/or other structural details of the second stop 512 and housing stop 604 can be varied in accordance with the details provided above with respect to the shaft stop 208 and first stop 220 in FIG. 7A. As described above, in some examples, at least one of the first surface or second surface of at least one of the shaft stop 208, housing stop 604, first stop 220, or second stop 512 comprises a compressible resilient material, such as an O-ring comprising a polymer material.

It will be appreciated that, in some examples, the housing stop 604 need not be part of the housing 218 per se, and can instead be a structure in a fixed relationship to any suitable fixed portion of the vehicle.

In the illustrated example, the cross-sectional plane of FIG. 7B is displaced along the axis of rotation 224 from the cross-sectional plane of FIG. 7A in a rearward direction, as shown by lines A-A and B-B in FIG. 6. However, it will be appreciated that some examples may displace the components of FIG. 7B from the components of FIG. 7A in a different direction, and/or may otherwise arrange the mutually engaging stops of FIG. 7B relative to the mutually engaging stops of FIG. 7A such that the rotating member 212 can rotate to independently engage the shaft stop 208 and the housing stop 604.

Thus, in some examples, the shaft 204 is rotatable by a driver about an axis of rotation 224. The shaft 204 has a shaft stop 208 extending radially outward from the axis of rotation 224. The shaft stop 208 has a first surface 702 and a second surface 704.

The housing 218 includes a housing stop 604. The housing stop 604 has a first surface 706 and a second surface 708.

The rotating member 212 is rotatable about the axis of rotation 224. The rotating member 212 has a first stop 220 having a first surface 710 that prevents rotation of the shaft 204 relative to the rotating member 212 in a first direction 718 when engaging the first surface 702 of the shaft stop 208, and a second surface 712 that prevents rotation of the shaft 204 relative to the rotating member 212 in a second direction 720 opposite the first direction 718 when engaging the second surface 704 of the shaft stop 208. The rotating member 212 has a second stop 512 having a first surface 714 that prevents rotation of the rotating member 212 relative to the housing 218 in the first direction 718 when engaging the first surface 706 of the housing stop 604, and a second surface 716 that prevents rotation of the rotating member 212 relative to the housing 218 in the second direction 720 when engaging the second surface 708 of the housing stop 604.

Thus, in some examples, the first stop 220 and the shaft stop 208 are at a first longitudinal position along the axis of rotation 224 (e.g., the plane of FIG. 7A), and the second stop 512 and the housing stop 604 are at a second longitudinal position, displaced from the first longitudinal position, along the axis of rotation 224 (e.g., the plane of FIG. 7B).

FIG. 8A illustrates the same simplified cross-sectional front view as FIG. 7A, showing the shaft 204 rotating through a third arc 802 starting from a first end position. FIG. 8B illustrates the same simplified cross-sectional front view as FIG. 7B, showing the rotating member 212 rotating through a fourth arc 804 ending at a second end position.

The position of the shaft 204 relative to the rotating member 212 shown in FIG. 8A, and the position of the rotating member 212 relative to the housing 218 shown in FIG. 8B, is referred to as the first end position, representing a maximal rotation of the shaft 204 in the first direction 718 of FIG. 7A-FIG. 7B (clockwise, in this example). In the first end position, the first surface 702 of the shaft stop 208 engages the first surface 710 of the first stop 220, and the first surface 714 of the second stop 512 engages the first surface 706 of the housing stop 604. It will be appreciated that the nature of this engagement can vary in different examples, and can include contact with only a small surface area of a given stop, such as contact with an O-ring encircling a stop.

From the first end position, the shaft 204 cannot rotate any farther in the first direction 718, because further torque applied to the shaft 204 in the first direction 718 results in force being applied by the shaft stop 208 to the first stop 220, which applies torque in the first direction 718 to the rotating member 212, which causes the second stop 512 to apply force to the housing stop 604, which is fixed in position and cannot rotate.

However, when the shaft 204 rotates from the first end position in the second direction 720, the shaft 204 begins to travel through a third arc 802 as shown in FIG. 8A. The third arc 802 can span up to nearly 360 degrees: specifically, the third arc 802 spans 360 degrees minus an angular width represented by a first stopped arc 806 corresponding to a width of the shaft stop 208 and first stop 220 where their surfaces engage. (It will be appreciated that the first stopped arc 806 is shown in FIG. 8A as a linear arrow to demonstrate the combined widths of the stops, but the first stopped arc 806 in fact defines an angular arc.) In the illustrated example, the first stopped arc 806 spans approximately 30 degrees. However, it will be appreciated that the shaft stop 208 and first stop 220 can instead be configured to provide a first stopped arc 806 of any suitable range of more or less than 30 degrees, such as between 10 degrees and 170 degrees, such that the third arc 802 is between 350 and 190 degrees. More generally, the first stopped arc 806 has an angular width of more than zero degrees, and in order to provide a multi-turn steering feedback actuator system capable of more than ±180 degrees of turning movement, the first stopped arc 806 can have an angular width of less than 360 degrees.

After the shaft 204 travels in the second direction 720 through the first third arc 802, the second surface 704 of the shaft stop 208 engages the second surface 712 of the first stop 220. At this point, any further rotation of the shaft 204 in the second direction 720 causes the rotating member 212 to rotate along with the shaft 204, as the shaft stop 208 applies force to the first stop 220, causing the rotating member 212 to rotate as the shaft 204 rotates.

This rotation of the rotating member 212, with the shaft 204, in the second direction 720 causes the second stop 512 of the rotating member 212 to travel along the fourth arc 804 shown in FIG. 8B. The rotating member 212 and the second stop 512 continue to rotate in the second direction 720 until the second surface 716 of the second stop 512 engages the second surface 708 of the housing stop 604 at a second end position, defining the maximum rotation of the shaft 204 in the second direction 720 (counter-clockwise, in this example). The fourth arc 804 can span up to nearly 360 degrees: specifically, the fourth arc 804 spans 360 degrees minus the angular width represented by a second stopped arc 808 corresponding to a width of the second stop 512 and housing stop 604 where their surfaces engage. In the illustrated example, the second stopped arc 808 spans approximately 30 degrees. However, as with the first stopped arc 806 described above, it will be appreciated that the second stop 512 and housing stop 604 can instead be configured to provide a second stopped arc 808 of any suitable range of more or less than 30 degrees, such as greater than zero degrees and less than 360 degrees.

In some examples, the first stopped arc 806 is at least 180 degrees. In some examples, the second stopped arc 808 is at least 180 degrees. In some examples, the first stopped arc 806 and second stopped arc 808 jointly span at least 360 degrees, thereby providing a steering range of motion of at least ±180 degrees. In some examples, the first stopped arc 806 and second stopped arc 808 jointly span at least 540 degrees, thereby providing a steering range of motion of at least ±270 degrees. In some examples, the first stopped arc 806 and second stopped arc 808 jointly span approximately 680 degrees, thereby providing a steering range of motion of at least ±340 degrees, representing an approximate upper limit on the range of motion enabled by the example shown in FIG. 2-FIG. 8B, accounting for a total of 10 degrees of stop width (the sum of the first stopped arc 806 and second stopped arc 808). Other suitable ranges can be selected or adjusted based on the desired driving experience and functionality of the steering system 144 of the vehicle 102 (FIG. 1).

Thus, in some examples, the shaft 204 rotates through an arc of at least 360 degrees between a first end position and a second end position. The first end position 810 is one in which the first surface 710 of the first stop 220 engages the first surface 702 of the shaft stop 208 and the first surface 714 of the second stop 512 engages the first surface 706 of the housing stop 604. The second end position 812 is one in which the second surface 712 of the first stop 220 engages the second surface 704 of the shaft stop 208 and the second surface 716 of the second stop 512 engages the second surface 708 of the housing stop 604. In some examples, the shaft 204 rotates through an arc of at least 540 degrees between the first end position and the second end position.

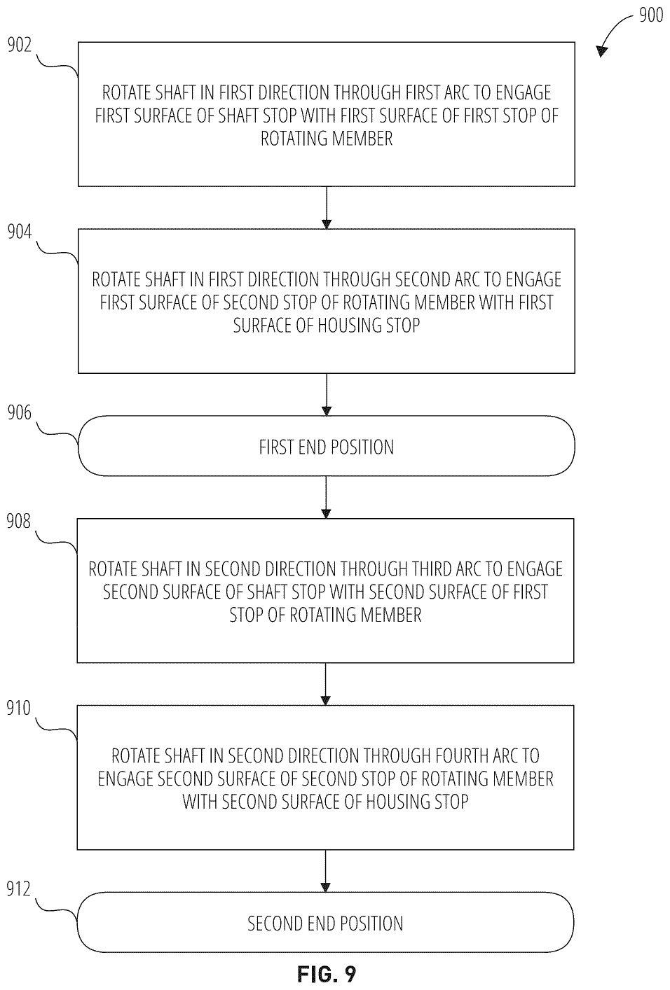

FIG. 9 is a flow diagram showing operations of a method 900 for rotating a steering column across a range of motion of more than ±180 degrees. The method 900 can be performed by the steering column assembly 200 in some examples.

Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method 900 includes rotating the shaft 204 in a first direction 718 (e.g., clockwise) through a first arc to engage a first surface 702 of the shaft stop 208 with a first surface 710 of a first stop 220 of the rotating member 212 at operation 902. In some examples, operation 902 corresponds to the movement of the shaft 204 and shaft stop 208 along the first arc (in first direction 718) shown in FIG. 7A.

According to some examples, the method 900 includes rotating the shaft 204 in the first direction 718 through a second arc to engage a first surface 714 of a second stop 512 of the rotating member 212 with a first surface 706 of the housing stop 604 at operation 904. In some examples, operation 902 corresponds to the movement of the rotating member 212 and second stop 512 along the second arc (in first direction 718) shown in FIG. 7B.

According to some examples, the steering column assembly 200 is considered to arrive at a first end position 906 (equivalent to first end position 810 from FIG. 8A-FIG. 8B) after the performance of operation 904.

According to some examples, the method 900 includes rotating the shaft 204 in a second direction 720, opposite the first direction 718 (e.g., counter-clockwise), through a third arc 802 to engage a second surface 704 of the shaft stop 208 with a second surface 712 of the first stop 220 of the rotating member 212 at operation 908. This corresponds to travelling through the third arc 802 shown in FIG. 8A.

According to some examples, the method 900 includes rotating the shaft 204 in the second direction 720 through a fourth arc 804 to engage a second surface 716 of the second stop 512 of the rotating member 212 with a second surface 708 of the housing stop 604 at operation 910. This corresponds to travelling through the fourth arc 804 shown in FIG. 8B.

According to some examples, the steering column assembly 200 is considered to arrive at a second end position 912 after the performance of operation 910.

As noted above, the ranges of angular movement of each arc (first arc, second arc, third arc 802, and fourth arc 804) can be defined variously in different examples, such that the method 900 provides multi-turn steering of more than the conventional limit of approximately ±170 degrees, such as ±180 degrees, ±270 degrees, or even amounts approaching ±360 degrees (such as ±340 degrees, accounting for the first stopped arc 806 and second stopped arc 808).

FIG. 10 shows an upper-front partial view of selected components of the steering column assembly 200 within the housing 218. Most of the components of the steering column assembly 200 are omitted for visibility, leaving only the rotating member 212, shaft 204 (including shaft stop 208), and housing 218 visible.

The shaft stop 208 can be seen extending radially outward from the shaft 204 at a first longitudinal position along the axis of rotation 224. The shaft stop 208 includes an O-ring 602 encircling the shaft stop 208; in this example, the O-ring 602 is retained in place by a corresponding groove around the circumference of the shaft stop 208. The O-ring 602 extends outward from the shaft stop 208 to engage the first stop 220 extending radially inward from the rotating member 212.

The second stop 512 is also shown at a second longitudinal position on the rotating member 212, the second longitudinal position being displaced rearward of the first longitudinal position along the axis of rotation 224. The second stop 512 engages the housing stop 604 to arrest rotation of the rotating member 212 relative to the housing 218. In the illustrated example, the second stop 512 is also shown to include an O-ring 602; as with the shaft stop 208, the O-ring 602 is retained in place by a corresponding groove around the circumference of the second stop 512. The O-ring 602 extends outward from the second stop 512 to engage the housing stop 604 extending radially inward from the rotating member 212.

The passage 510 interconnects the cavity of the housing 218 containing the steering column assembly 200 with the cavity of the actuator housing (not shown) containing the actuator (not shown), as described above. It will be appreciated that the steering column assembly 200 described herein is not limited to use with a drive mechanism such as a gearbox or belt: in some examples, the steering column assembly 200 can receive feedback through a direct-drive system that applied feedback torque directly to the shaft 204 or another component of the steering column assembly 200.

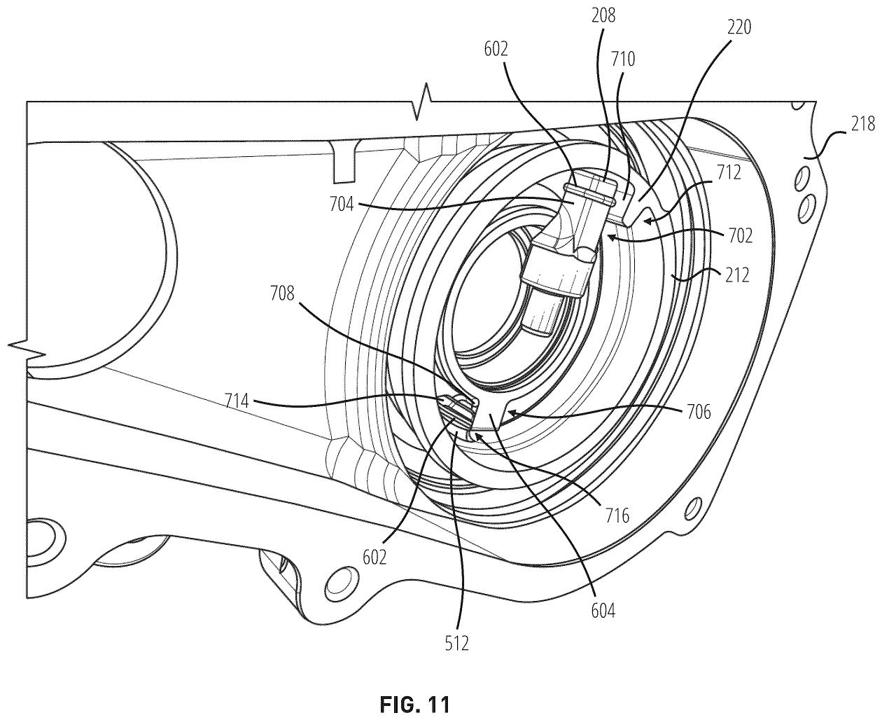

FIG. 11 shows the same isometric upper-front partial view as FIG. 10, but omits the shaft 204 for greater visibility. Further details of the rotating member 212 (including first stop 220 and second stop 512), the shaft stop 208, and the housing stop 604 can be seen more clearly. The shaft stop 208 has first surface 702 and second surface 704; the housing stop 604 has first surface 706 and second surface 708; the first stop 220 has first surface 710 and second surface 712; and the second stop 512 has first surface 714 and second surface 716.

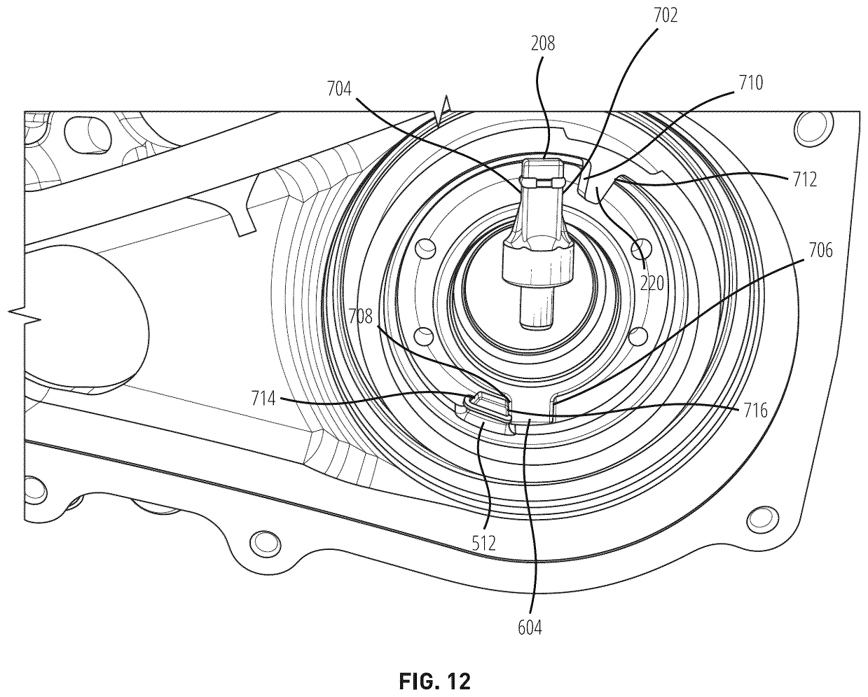

FIG. 12 shows a different partial view of the components of the steering column assembly 200 from FIG. 11. Further details of the rotating member 212 (including first stop 220 and second stop 512), the shaft stop 208, and the housing stop 604 can be seen more clearly, such as first surface 702 and second surface 704; first surface 706 and second surface 708; first surface 710 and second surface 712; and first surface 714 and second surface 716.

The examples described above relate to a multi-turn steering feedback actuator system, suitable for use in steer-by-wire applications. The system includes a steering column assembly with a shaft rotatable by a driver, a housing, and a rotating member. The shaft includes a shaft stop, while the housing includes a housing stop. The rotating member features two stops: a first stop that interacts with the shaft stop, and a second stop that interacts with the housing stop. This configuration allows for a range of motion exceeding 170 degrees in each direction, potentially up to approximately 340 degrees total, while still providing mechanical end stops to prevent unlimited rotation. The stops can incorporate compressible resilient materials, such as O-rings, on one or more contact surfaces to provide a softer feel and reduce wear. The system can also include an actuator coupled to the shaft via a drive mechanism to provide force feedback, mimicking the sensation of traditional steering systems while allowing for the benefits of steer-by-wire technology.

In some examples, the steering column assembly 200 could be further modified to incorporate a third or further stop ring or rotating component that permits ranges of motion greater than ±340 degrees, or greater than ±360 degrees, such as ±510 degrees or more, by allowing the third or further components to each rotate an amount approaching ±180 degrees.

Other technical features may be readily apparent to one skilled in the art from the figures, descriptions, and claims herein.

### EXAMPLES

Some embodiments may include one or more of the following examples.

Example 1 is a steering column assembly, comprising: a shaft rotatable about an axis of rotation, the shaft comprising a shaft stop extending radially outward from the axis of rotation, the shaft stop comprising a first surface and a second surface; a housing comprising a housing stop, the housing stop comprising a first surface and a second surface; and a rotating member rotatable about the axis of rotation, the rotating member comprising: a first stop, comprising: a first surface that prevents rotation of the shaft relative to the rotating member in a first direction when engaging the first surface of the shaft stop; and a second surface that prevents rotation of the shaft relative to the rotating member in a second direction opposite the first direction when engaging the second surface of the shaft stop; and a second stop, comprising: a first surface that prevents rotation of the rotating member relative to the housing in the first direction when engaging the first surface of the housing stop; and a second surface that prevents rotation of the rotating member relative to the housing in the second direction when engaging the second surface of the housing stop.

Example 2 includes the subject matter of Example 1, wherein: the shaft rotates through an arc of at least 360 degrees between a first end position and a second end position, the first end position comprising the first surface of the first stop engaging the first surface of the shaft stop and the first surface of the second stop engaging the first surface of the housing stop, and the second end position comprising the second surface of the first stop engaging the second surface of the shaft stop and the second surface of the second stop engaging the second surface of the housing stop.

Example 3 includes the subject matter of Example 2, wherein: the shaft rotates through an arc of at least 540 degrees between the first end position and the second end position.

Example 4 includes the subject matter of Examples 1-3, wherein: the first stop and the shaft stop are at a first longitudinal position along the axis of rotation; and the second stop and the housing stop are at a second longitudinal position, displaced from the first longitudinal position, along the axis of rotation.

Example 5 includes the subject matter of Examples 1-4, wherein: at least one of the first surface or second surface of at least one of the shaft stop, housing stop, first stop, or second stop comprises a compressible resilient material.

Example 6 includes the subject matter of Example 5, wherein: the compressible resilient material comprises an O-ring comprising a polymer material.

Example 7 includes the subject matter of Examples 1-6, wherein: the shaft comprises an outer radial surface for engaging a drive mechanism coupled to an actuator.

Example 8 is a method, comprising: rotating a shaft about an axis of rotation in a first direction through a first arc, the shaft comprising a shaft stop extending radially outward from the axis of rotation, the shaft stop comprising a first surface; engaging the first surface of the shaft stop with a first surface of a first stop of a rotating member; continuing to rotate the shaft about the axis of rotation in the first direction through a second arc, the engagement of the first surface of the shaft stop with the first surface of the first stop causing the rotating member to rotate in the first direction with the shaft through the second arc; and engaging a first surface of a second stop of the rotating member with a first surface of a housing stop of a housing, the housing being non-rotating, the engagement of the first surface of the second stop with the first surface of the housing stop stopping the rotating member from rotating, the engagement of the first surface of the shaft stop with the first surface of the first stop stopping the shaft from rotating.

Example 9 includes the subject matter of Example 8, further comprising, after engaging the first surface of the second stop with the first surface of the housing stop: rotating the shaft about the axis of rotation in a second direction, opposite the first direction, through a third arc; engaging a second surface of the shaft stop with a second surface of the first stop; continuing to rotate the shaft about the axis of rotation in the second direction through a fourth arc, the engagement of the second surface of the shaft stop with the second surface of the first stop causing the rotating member to rotate in the second direction with the shaft through the fourth arc; and engaging a second surface of the second stop with a second surface of the housing stop, the engagement of the second surface of the second stop with the second surface of the housing stop stopping the rotating member from rotating, the engagement of the second surface of the shaft stop with the second surface of the first stop stopping the shaft from rotating.

Example 10 includes the subject matter of Example 9, wherein: the third arc spans more than 180 degrees.

Example 11 includes the subject matter of Examples 9-10, wherein: the fourth arc spans more than 180 degrees.

Example 12 includes the subject matter of Examples 9-11, wherein: the third arc and the fourth arc jointly span more than 360 degrees.

Example 13 includes the subject matter of Examples 9-12, wherein: the third arc and the fourth arc jointly span more than 540 degrees.

Example 14 is a multi-turn steering feedback actuator system, comprising: a steering column assembly comprising: a shaft rotatable about an axis of rotation, the shaft comprising a shaft stop extending radially outward from the axis of rotation, the shaft stop comprising a first surface and a second surface; a housing comprising a housing stop, the housing stop comprising a first surface and a second surface; and a rotating member rotatable about the axis of rotation, the rotating member comprising: a first stop, comprising: a first surface that prevents rotation of the shaft relative to the rotating member in a first direction when engaging the first surface of the shaft stop; and a second surface that prevents rotation of the shaft relative to the rotating member in a second direction opposite the first direction when engaging the second surface of the shaft stop; and a second stop, comprising: a first surface that prevents rotation of the rotating member relative to the housing in the first direction when engaging the first surface of the housing stop; and a second surface that prevents rotation of the rotating member relative to the housing in the second direction when engaging the second surface of the housing stop; and an actuator coupled to the shaft of the steering column assembly by a drive mechanism, the actuator providing force feedback to the shaft via the drive mechanism.

Example 15 includes the subject matter of Example 14, wherein: the shaft rotates through an arc of at least 360 degrees between a first end position and a second end position, the first end position comprising the first surface of the first stop engaging the first surface of the shaft stop and the first surface of the second stop engaging the first surface of the housing stop, and the second end position comprising the second surface of the first stop engaging the second surface of the shaft stop and the second surface of the second stop engaging the second surface of the housing stop.

Example 16 includes the subject matter of Example 15, wherein: the shaft rotates through an arc of at least 540 degrees between the first end position and the second end position.

Example 17 includes the subject matter of Examples 14-16, wherein: the first stop and the shaft stop are at a first longitudinal position along the axis of rotation; and the second stop and the housing stop are at a second longitudinal position, displaced from the first longitudinal position, along the axis of rotation.

Example 18 includes the subject matter of Examples 14-17, wherein: at least one of the first surface or second surface of at least one of the shaft stop, housing stop, first stop, or second stop comprises a compressible resilient material.

Example 19 includes the subject matter of Example 18, wherein: the compressible resilient material comprises an O-ring comprising a polymer material.

Example 20 includes the subject matter of Examples 1-19, wherein: the shaft comprises an outer radial surface for engaging the drive mechanism.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all of the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration.

Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few. The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Although the described flow diagrams herein can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially, concurrently, or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A steering column assembly, comprising:
a shaft rotatable about an axis of rotation, the shaft comprising a shaft stop extending radially outward from the axis of rotation, the shaft stop comprising a first surface and a second surface;
a housing comprising a housing stop, the housing stop comprising a first surface and a second surface; and
a rotating member rotatable about the axis of rotation, the rotating member comprising:
a first stop, comprising:
a first surface that prevents rotation of the shaft relative to the rotating member in a first direction when engaging the first surface of the shaft stop; and
a second surface that prevents rotation of the shaft relative to the rotating member in a second direction opposite the first direction when engaging the second surface of the shaft stop; and
a second stop, comprising:
a first surface that prevents rotation of the rotating member relative to the housing in the first direction when engaging the first surface of the housing stop; and
a second surface that prevents rotation of the rotating member relative to the housing in the second direction when engaging the second surface of the housing stop.

2. The steering column assembly of claim 1, wherein:
the shaft rotates through an arc of at least 360 degrees between a first end position and a second end position,
the first end position comprising the first surface of the first stop engaging the first surface of the shaft stop and the first surface of the second stop engaging the first surface of the housing stop, and
the second end position comprising the second surface of the first stop engaging the second surface of the shaft stop and the second surface of the second stop engaging the second surface of the housing stop.

3. The steering column assembly of claim 2, wherein:
the shaft rotates through an arc of at least 540 degrees between the first end position and the second end position.

4. The steering column assembly of claim 1, wherein:
the first stop and the shaft stop are at a first longitudinal position along the axis of rotation; and
the second stop and the housing stop are at a second longitudinal position, displaced from the first longitudinal position, along the axis of rotation.

5. The steering column assembly of claim 1, wherein:
at least one of the first surface or second surface of at least one of the shaft stop, housing stop, first stop, or second stop comprises a compressible resilient material.

6. The steering column assembly of claim 5, wherein:
the compressible resilient material comprises an O-ring comprising a polymer material.

7. The steering column assembly of claim 1, wherein:
the shaft comprises an outer radial surface for engaging a drive mechanism coupled to an actuator.

8. A method, comprising:
rotating a shaft about an axis of rotation in a first direction through a first arc, the shaft comprising a shaft stop extending radially outward from the axis of rotation, the shaft stop comprising a first surface;
engaging the first surface of the shaft stop with a first surface of a first stop of a rotating member;
continuing to rotate the shaft about the axis of rotation in the first direction through a second arc, the engagement of the first surface of the shaft stop with the first surface of the first stop causing the rotating member to rotate in the first direction with the shaft through the second arc; and
engaging a first surface of a second stop of the rotating member with a first surface of a housing stop of a housing, the housing being non-rotating, the engagement of the first surface of the second stop with the first surface of the housing stop stopping the rotating member from rotating, the engagement of the first surface of the shaft stop with the first surface of the first stop stopping the shaft from rotating.

9. The method of claim 8, further comprising:
after engaging the first surface of the second stop with the first surface of the housing stop:
rotating the shaft about the axis of rotation in a second direction, opposite the first direction, through a third arc;
engaging a second surface of the shaft stop with a second surface of the first stop;
continuing to rotate the shaft about the axis of rotation in the second direction through a fourth arc, the engagement of the second surface of the shaft stop with the second surface of the first stop causing the rotating member to rotate in the second direction with the shaft through the fourth arc; and
engaging a second surface of the second stop with a second surface of the housing stop, the engagement of the second surface of the second stop with the second surface of the housing stop stopping the rotating member from rotating, the engagement of the second surface of the shaft stop with the second surface of the first stop stopping the shaft from rotating.

10. The method of claim 9, wherein:
the third arc spans more than 180 degrees.

11. The method of claim 9, wherein:
the fourth arc spans more than 180 degrees.

12. The method of claim 9, wherein:
the third arc and the fourth arc jointly span more than 360 degrees.

13. The method of claim 9, wherein:
the third arc and the fourth arc jointly span more than 540 degrees.

14. A multi-turn steering feedback actuator system, comprising:
a steering column assembly comprising:
a shaft rotatable about an axis of rotation, the shaft comprising a shaft stop extending radially outward from the axis of rotation, the shaft stop comprising a first surface and a second surface;
a housing comprising a housing stop, the housing stop comprising a first surface and a second surface; and
a rotating member rotatable about the axis of rotation, the rotating member comprising:
a first stop, comprising:
a first surface that prevents rotation of the shaft relative to the rotating member in a first direction when engaging the first surface of the shaft stop; and
a second surface that prevents rotation of the shaft relative to the rotating member in a second direction opposite the first direction when engaging the second surface of the shaft stop; and
a second stop, comprising:
a first surface that prevents rotation of the rotating member relative to the housing in the first direction when engaging the first surface of the housing stop; and
a second surface that prevents rotation of the rotating member relative to the housing in the second direction when engaging the second surface of the housing stop; and
an actuator coupled to the shaft of the steering column assembly by a drive mechanism, the actuator providing force feedback to the shaft via the drive mechanism.

15. The multi-turn steering feedback actuator system of claim 14, wherein:
the shaft rotates through an arc of at least 360 degrees between a first end position and a second end position,
the first end position comprising the first surface of the first stop engaging the first surface of the shaft stop and the first surface of the second stop engaging the first surface of the housing stop, and
the second end position comprising the second surface of the first stop engaging the second surface of the shaft stop and the second surface of the second stop engaging the second surface of the housing stop.

16. The multi-turn steering feedback actuator system of claim 15, wherein:
the shaft rotates through an arc of at least 540 degrees between the first end position and the second end position.

17. The multi-turn steering feedback actuator system of claim 14, wherein:
the first stop and the shaft stop are at a first longitudinal position along the axis of rotation; and
the second stop and the housing stop are at a second longitudinal position, displaced from the first longitudinal position, along the axis of rotation.

18. The multi-turn steering feedback actuator system of claim 14, wherein:
at least one of the first surface or second surface of at least one of the shaft stop, housing stop, first stop, or second stop comprises a compressible resilient material.

19. The multi-turn steering feedback actuator system of claim 18, wherein:
the compressible resilient material comprises an O-ring comprising a polymer material.

20. The multi-turn steering feedback actuator system of claim 18, wherein:
the shaft comprises an outer radial surface for engaging the drive mechanism.
